(19) United States
(12) Patent Application Publication
(10) Pub. No.: US 2026/0010813 A1
(43) Pub. Date: Jan. 8, 2026

(54) INFORMATION PROCESSING APPARATUS AND QUANTUM CIRCUIT WEIGHT REDUCTION METHOD

(71) Applicant: Fujitsu Limited, Kawasaki-shi (JP)

(72) Inventor: Satoshi IMAMURA, Kawasaki (JP)

(73) Assignee: Fujitsu Limited, Kawasaki-shi (JP)

(21) Appl. No.: 19/329,621

(22) Filed: Sep. 16, 2025

Related U.S. Application Data
(63) Continuation of application No. PCT/JP2024/009240, filed on Mar. 11, 2024.

(30) Foreign Application Priority Data
Apr. 14, 2023 (JP) 2023-066045

(51) Int. Cl. G06N 10/20; G06N 10/60

(52) U.S. Cl. CPC G06N 10/20; G06N 10/60

(57) ABSTRACT

A processing unit acquires first quantum circuit information representing a first quantum circuit that includes a plurality of Rz gates and a plurality of groups of CNOT gates, each group accompanying a corresponding one of the plurality of Rz gates, and that is used for VQE, and the number of Rz gates for each angle parameter. The processing unit determines deletion target Rz gates from the plurality of Rz gates included in the first quantum circuit based on the first quantum circuit information and the number of Rz gates. The processing unit generates second quantum circuit information representing a second quantum circuit obtained by deleting the determined Rz gates and CNOT gates accompanying the determined Rz gates from the first quantum circuit. The processing unit outputs the second quantum circuit information.

### CROSS-REFERENCE TO RELATED APPLICATIONS

This application is a continuation application of International Application PCT/JP2024/009240 filed on Mar. 11, 2024, which designated the U.S., which is based upon and claims the benefit of priority of the prior Japanese Patent Application No. 2023-066045, filed on Apr. 14, 2023, the entire contents of which are incorporated herein by reference.

### FIELD

The embodiments discussed herein relate to an information processing apparatus and a quantum circuit weight reduction method.

### BACKGROUND

Quantum chemical calculation is a method of calculating the energy of a molecule to be analyzed in order to analyze the structure and properties of the molecule from the electronic state. Variational quantum eigensolver (VQE) is one of the quantum chemical calculation algorithms. VQE is also one of the variational algorithms that are executable in an intermediate-scale quantum device without error correction (sometimes referred to as noisy intermediate-scale quantum (NISQ)).

In VQE, a trial wave function representing the electronic state of a molecule is expressed using a quantum circuit having the rotation angle of a rotation gate as a parameter. The quantum circuit or trial wave function may also be referred to as ansatz. The energy of the molecule is calculated using such a quantum circuit. The optimization of parameters by a classical process and a calculation process on the energy by the quantum circuit are repeated such that the energy is minimized. The accuracy and computational amount of the VQE greatly depend on the type of ansatz. Unitary coupled cluster singles and doubles (UCCSD) ansatz is an example of ansatz that enables accurate computation.

Conventionally, a quantum circuit optimization technique for reducing quantum resources by performing Pauli term merging, quantum resource re-embedding, or merge sorting has been proposed (see, for example, International Publication Pamphlet No. WO2020/118285).

### SUMMARY

In one aspect, there is provided a non-transitory computer-readable recording medium storing therein a computer program that causes a computer to execute a process including: acquiring first quantum circuit information representing a first quantum circuit that includes a plurality of Rz gates and a plurality of groups of CNOT gates, each group accompanying a corresponding one of the plurality of Rz gates, and that is used for variational quantum eigensolver (VQE), and a number of Rz gates for each angle parameter; determining a deletion target Rz gate from the plurality of Rz gates included in the first quantum circuit based on the first quantum circuit information and the number of Rz gates; generating second quantum circuit information representing a second quantum circuit obtained by deleting the determined Rz gate and a CNOT gate accompanying the determined Rz gate from the first quantum circuit; and outputting the second quantum circuit information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing apparatus according to a first embodiment;

FIG. 2 is a diagram illustrating an example of a first quantum circuit;

FIG. 3 is a diagram illustrating the relationship between the number of CNOT gates and the error in a simulation without noise and in a simulation with noise;

FIG. 4 is a diagram illustrating an example of a second quantum circuit;

FIG. 5 is a block diagram illustrating a hardware example of an information processing apparatus according to a second embodiment;

FIG. 6 is a block diagram illustrating a functional example of the information processing apparatus;

FIG. 7 is a diagram illustrating a connection example of physical qubits and an example of a quantum circuit before and after transpiration;

FIG. 8 is a flowchart illustrating an example of a processing procedure of a quantum circuit weight reduction method;

FIG. 9 is a flowchart illustrating an example of an Rz/CNOT group determination procedure;

FIG. 10 is a flowchart illustrating an example of a deletion target Rz gate determination procedure;

FIG. 11 is a flowchart illustrating an example of a procedure for adding CNOT gates to a deletion list;

FIG. 12 is a diagram illustrating an example of the correlation among rz_per_param, the error, and the number of CNOT gates; and

FIGS. 13A and 13B are diagrams each illustrating an example of an effect of the quantum circuit weight reduction method according to the second embodiment.

### DESCRIPTION OF EMBODIMENTS

In NISQ, the error of the VQE may increase due to a noise-induced error. Since the error rate of the individual CNOT gate among the quantum gates is particularly high, a quantum circuit having more CNOT gates represents a greater increase width of the noise-induced error.

Hereinafter, embodiments of the present embodiments will be described with reference to the drawings.

### First Embodiment

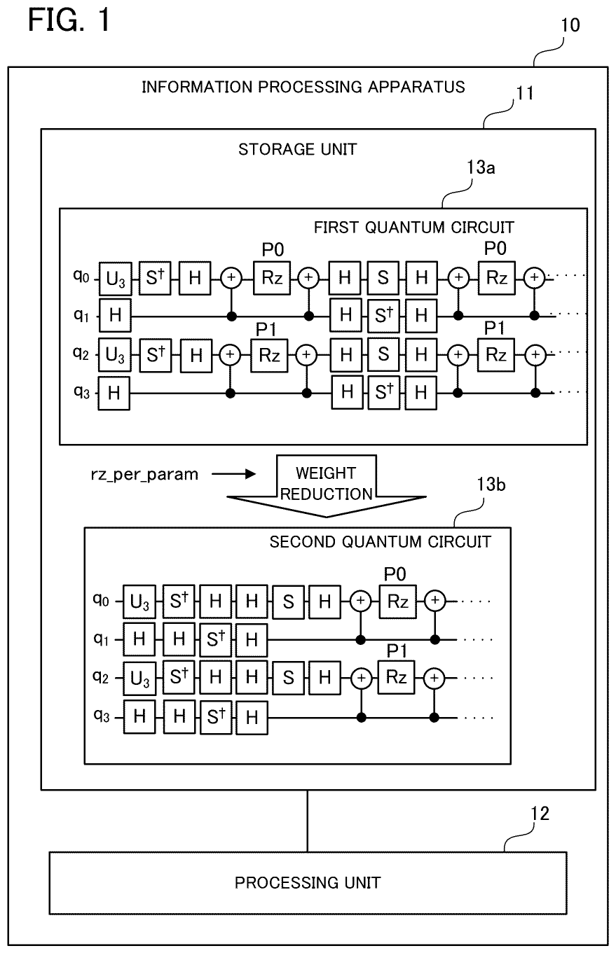

FIG. 1 is a diagram illustrating an information processing apparatus according to a first embodiment.

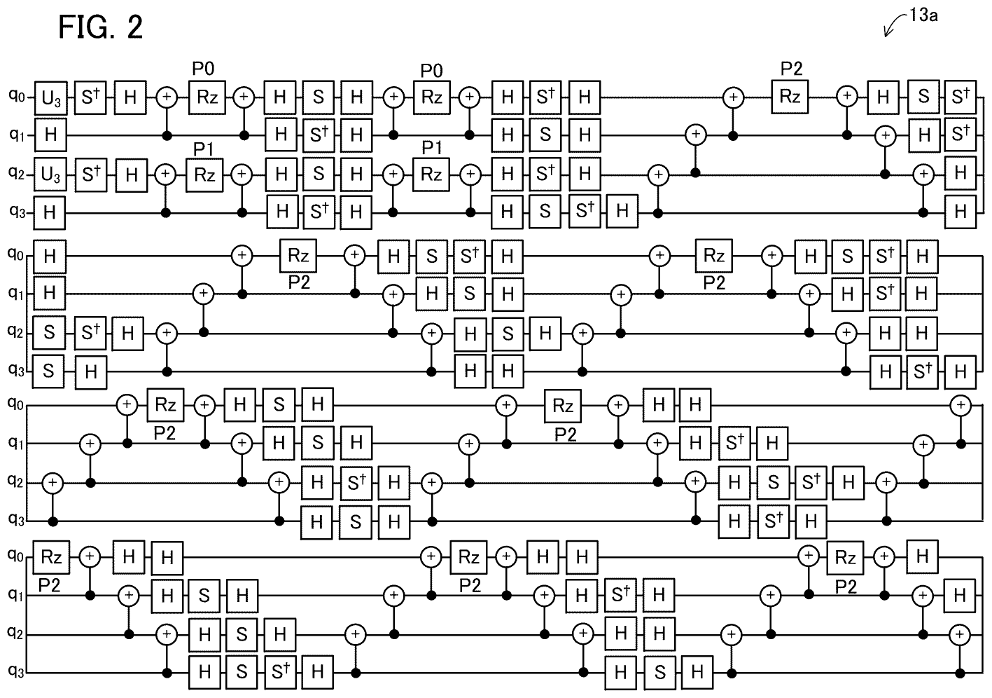

FIG. 2 is a diagram illustrating an example of a first quantum circuit.

An information processing apparatus 10 according to the first embodiment reduces the VQE error due to a noise-induced error by reducing the weight of a quantum circuit through a process to be described below. The information processing apparatus 10 may be a client apparatus or a server apparatus. The information processing apparatus 10 may be referred to as a computer.

The information processing apparatus 10 includes a storage unit 11 and a processing unit 12. The storage unit 11 may be a volatile semiconductor memory such as a random access memory (RAM) or a non-volatile storage such as a hard disk drive (HDD) or a flash memory. The processing unit 12 is, for example, a processor such as a central processing unit (CPU), a graphics processing unit (GPU), or a digital signal processor (DSP). However, the processing unit 12 may include an electronic circuit such as an application specific integrated circuit (ASIC) or a field programmable gate array (FPGA). The processor executes, for example, a program stored in a memory (which may be the storage unit 11) such as a RAM. A group of processors may also be referred to as a multiprocessor or simply “processor”.

The storage unit 11 stores first quantum circuit information representing a first quantum circuit 13a used for VQE. The storage unit 11 may store second quantum circuit information representing a second quantum circuit. The second quantum circuit is obtained by reducing the weight of the first quantum circuit 13a through the process described below. The storage unit 11 may store the number of Rz gates for each angle parameter described below.

FIG. 1 illustrates a part of the first quantum circuit 13a. The entire first quantum circuit 13a is illustrated in FIG. 2.

The example of the first quantum circuit 13a illustrated in FIGS. 1 and 2 is UCCSD ansatz of a hydrogen (H₂) molecule represented by four qubits q₀ to q₃. In FIG. 2, quantum operations by various quantum gates on the qubits q₀ to q₃ are illustrated in four stages from the upper left to the lower right. The right end of each stage is connected to the left end of the next stage.

In the first quantum circuit 13a, “U₃” is a U₃ gate that performs a rotation operation based on three angle parameters θ, φ, and λ on a certain quantum state represented on the Bloch sphere. “S” is an S gate that performs a rotation operation of φ=π/2 on a certain quantum state represented on the Bloch sphere. “S” with a superscript dagger is an S dagger gate that performs a rotation operation of φ=−π/2 on a certain quantum state represented on the Bloch sphere. “H” is a Hadamard gate that performs a rotation operation of 180° on a certain quantum state represented on the Bloch sphere, using an axis inclined by 45° between the Z axis and the X axis as the rotation center. “Rz” is an Rz gate that performs a rotation operation of θ around the Z axis on a certain quantum state represented on the Bloch sphere. “+” is a CNOT gate that inverts the value of the target qubit if the control qubit is |1>. The CNOT gate generates quantum entanglement between two qubits.

In FIGS. 1 and 2, the angle parameters of the Rz gates are represented by parameters P0, P1, and P2. In the example in FIG. 2, there are two Rz gates that perform the rotation operation using the parameter P0, two Rz gates that perform the rotation operation using the parameter P1, and eight Rz gates that perform the rotation operation using the parameter P2.

As illustrated in FIGS. 1 and 2, each Rz gate is accompanied by a group of CNOT gates. Each of the two Rz gates using the parameter P0 is accompanied by two CNOT gates, and each of the two Rz gates using the parameter P1 is accompanied by two CNOT gates. Each of the eight Rz gates using parameter P2 is accompanied by six CNOT gates.

The processing unit 12 acquires first quantum circuit information representing the first quantum circuit 13a and the number of Rz gates for each angle parameter. The processing unit 12 acquires the first quantum circuit information and the number of Rz gates for each angle parameter from, for example, the storage unit 11. The processing unit 12 may acquire the first quantum circuit information or the number of Rz gates for each angle parameter from the outside of the information processing apparatus 10.

The number of Rz gates for each angle parameter is an input value specified by a user. In FIG. 1, the number of Rz gates for each angle parameter is indicated as “rz_per_param.”

In an ideal simulation calculation without noise, as the number of Rz gates for each angle parameter increases, the angle parameter is adjusted more finely, and thus a smaller error is achieved. However, in actual quantum devices with noise, when the number of Rz gates is larger, the error tends to increase more due to noise. This is because when the number of Rz gates is larger, the number of CNOT gates accompanying the Rz gates also becomes larger. As described above, since the error rate of the individual CNOT gate is particularly large, a quantum circuit having more CNOT gates represents a greater increase width of the noise-induced error.

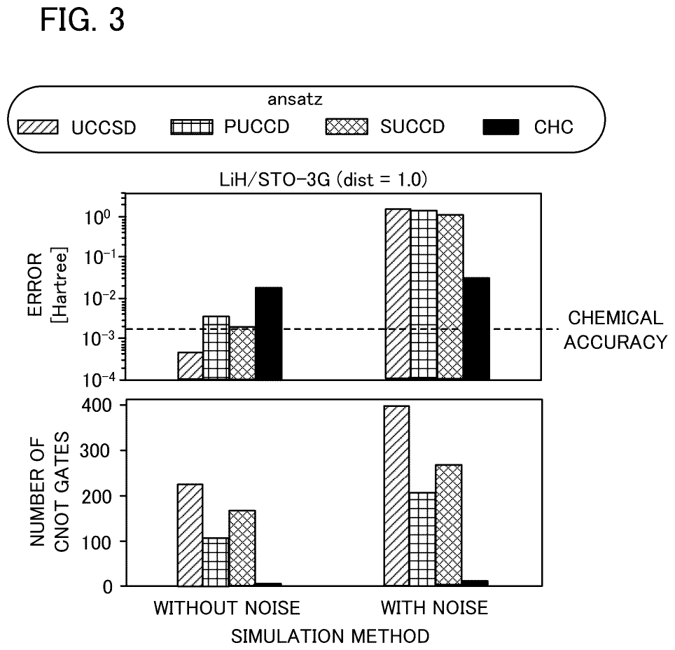

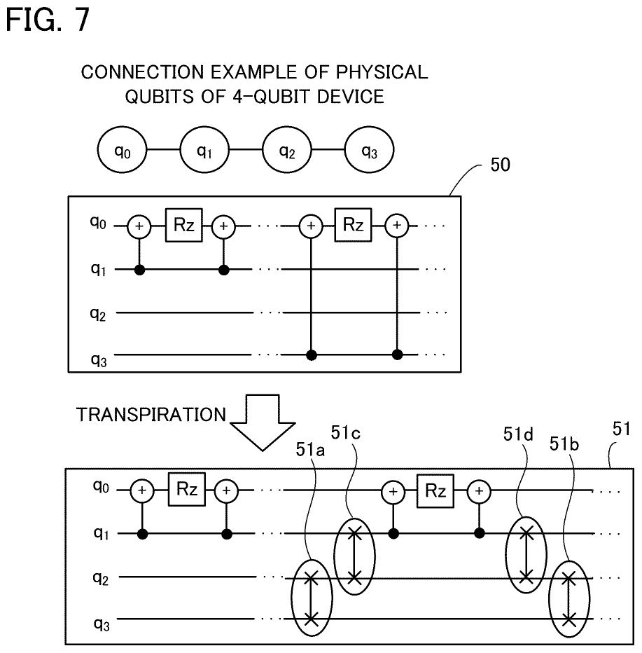

FIG. 3 is a diagram illustrating the relationship between the number of CNOT gates and the error in a simulation without noise and in a simulation with noise. In the simulation with noise, a noise model based on a quantum device with a limited connection between physical qubits is used. There are cases in which transpiration (see FIG. 7 to be described below) is performed on a quantum circuit for such a quantum device. In these cases, the number of CNOT gates in this quantum circuit may increase after the transpiration (for example, the first quantum circuit 13a). Therefore, the number of CNOT gates of the model with noise is larger than that of the model without noise.

In the example in FIG. 3, ansatz of LiH (lithium hydride) is used. The basis set used is STO-3G. Dist=1.0 indicates that the interatomic distance between a lithium atom and a hydrogen atom is 1.0 Å. The error is the difference between the ground state energy of LiH obtained by the full configuration interaction method and the ground state energy of LiH obtained by VQE.

In the example in FIG. 3, four types of ansatz, UCCSD, parallel unitary coupled cluster doubles (PUCCD), symmetric unitary coupled cluster doubles (SUCCD), and compact heuristic for chemistry (CHC) are used.

In the quantum chemical calculation, it is preferable to keep the error within chemical accuracy. Keeping the error within chemical accuracy is equivalent to making the error smaller than 1.6 mHartree. In the simulation without noise, when UCCSD ansatz having a larger number of CNOT gates than other ansatz is used, the error is within the chemical accuracy. However, in the simulation with noise, ansatz having a larger number of CNOT gates indicates a greater increase width of the noise-induced error. In the example in FIG. 3, although the UCCSD ansatz indicates the highest accuracy in the simulation without noise, the UCCSD ansatz indicates a larger error than the other ansatz in the simulation with noise.

The number of CNOT gates causing such an increase in error increases as the number of Rz gates increases as described above.

Therefore, in the information processing apparatus 10 illustrated in FIG. 1, the processing unit 12 reduces the number of CNOT gates accompanying the Rz gates by reducing the number of Rz gates as follows, and consequently reduces the VQE error due to the noise-induced error.

The processing unit 12 determines the deletion target Rz gates from the first quantum circuit 13a based on the acquired first quantum circuit information and rz_per_param. For example, when rz_per_param=1 for all of the parameters P0 to P2, the processing unit 12 determines the Rz gates other than one Rz gate as the deletion target Rz gates, for each of the parameters P0 to P2.

Next, the processing unit 12 generates second quantum circuit information representing a second quantum circuit 13b obtained by deleting the determined Rz gates and the CNOT gates accompanying the determined Rz gates from the first quantum circuit 13a.

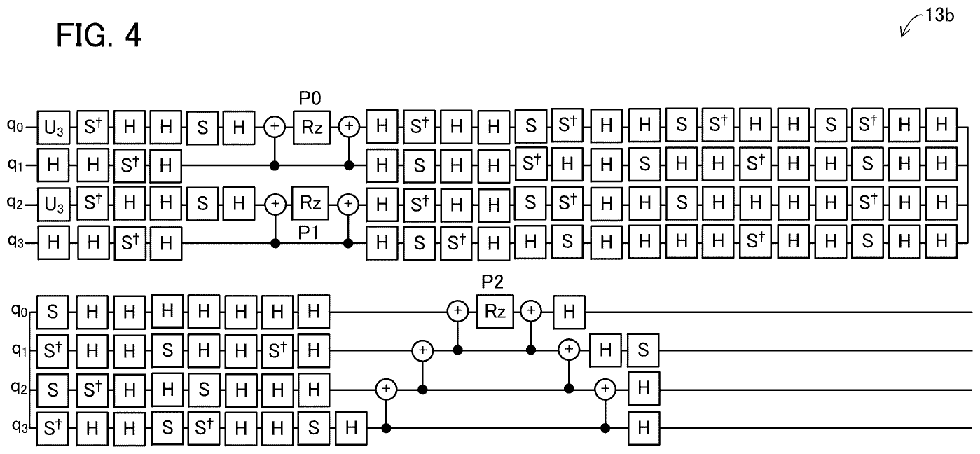

FIG. 4 is a diagram illustrating an example of the second quantum circuit. FIG. 1 also illustrates a part of the second quantum circuit 13b.

FIGS. 1 and 4 each illustrate a deletion example of Rz gates and CNOT gates in a case where the Rz gates other than one Rz gate are determined as the deletion targets for each of the parameters P0 to P2 in the first quantum circuit 13a illustrated in FIG. 2.

When there are a plurality of Rz gates having a certain angle parameter, unit the processing 12 preferentially sets an Rz gate that acts earlier on the qubits q₀ to q₃ as a deletion target in the first quantum circuit 13a, for example. This is because it is considered that an Rz gate that acts later is more important for the calculation result. However, the processing unit 12 may determine a preferentially deleted Rz gate according to another rule.

As illustrated in FIGS. 1 and 4, the second quantum circuit 13b whose weight has been reduced by the above method has one Rz gate for each of the parameters P0 to P2. While the number of CNOT gates is 56 in the first quantum circuit 13a, the number of CNOT gates is 10 in the second quantum circuit 13b.

Thereafter, the processing unit 12 outputs second quantum circuit information representing the second quantum circuit 13b. The processing unit 12 may store the second quantum circuit information in a non-volatile storage, display the second quantum circuit information on a display device, or transmit the second quantum circuit information to another information processing apparatus.

As described above, the processing unit 12 of the information processing apparatus 10 acquires first quantum circuit information representing the first quantum circuit 13a that includes a plurality of Rz gates and a plurality of groups of CNOT gates, each group accompanying a corresponding one of the plurality of Rz gates, and that is used for VQE. In addition, the processing unit 12 acquires the number of Rz gates for each angle parameter. Further, the processing unit 12 determines deletion target Rz gates from the first quantum circuit 13a based on the first quantum circuit information and the number of Rz gates. Next, the processing unit 12 generates second quantum circuit information representing the second quantum circuit 13b obtained by deleting the determined Rz gates and the CNOT gates accompanying the determined Rz gates from the first quantum circuit 13a, and outputs the second quantum circuit information.

Since the second quantum circuit in which the number of CNOT gates has been reduced is obtained by the above-described process, when the second quantum circuit is mounted on an actual quantum device such as NISQ and VQE is executed, the error due to the noise-induced error is reduced. This makes it possible to perform quantum chemical calculation with high accuracy, and to consequently contribute to drug discovery, new material development, and the like.

### Second Embodiment

Next, a second embodiment will be described.

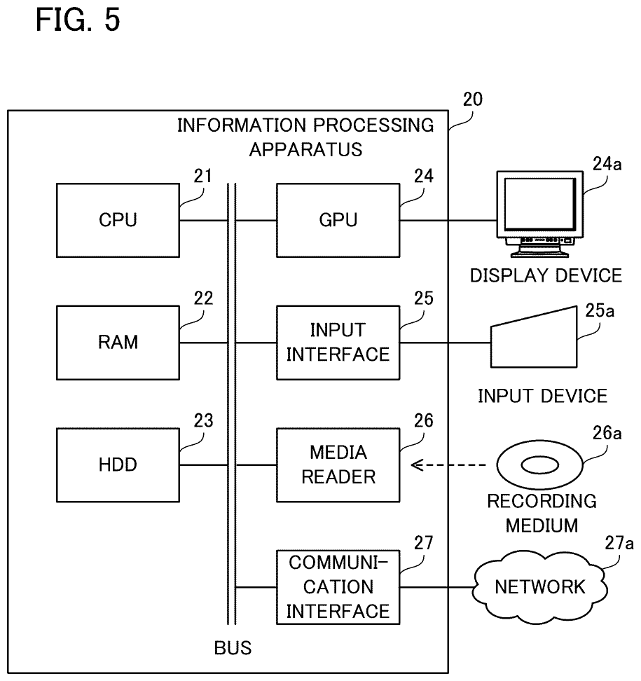

FIG. 5 is a block diagram illustrating a hardware example of an information processing apparatus according to a second embodiment.

An information processing apparatus 20 may be a client apparatus or a server apparatus. The information processing apparatus 20 may be referred to as a computer.

The information processing apparatus 20 includes a CPU 21, a RAM 22, an HDD 23, a GPU 24, an input interface 25, a media reader 26, and a communication interface 27, which are connected to a bus. The CPU 21 corresponds to the processing unit 12 according to the first embodiment. The RAM 22 or the HDD 23 corresponds to the storage unit 11 according to the first embodiment.

The CPU 21 is a processor that executes program commands. The CPU 21 loads a program and data stored in the HDD 23 into the RAM 22 and executes the program. The CPU 21 may include a plurality of processor cores. The information processing apparatus 20 may include a plurality of processors. A processor that executes a certain process among a plurality of processes of the information processing apparatus 20 may be different from a processor that executes a process different from the certain process among the plurality of processes. The processor may be referred to as processor circuitry. A group of a plurality of processors (multiprocessor) may be referred to as “processor”.

The RAM 22 is a volatile semiconductor memory that temporarily stores a program executed by the CPU 21 and data used for calculation by the CPU 21. The information processing apparatus 20 may include a volatile memory of a type other than RAM.

The HDD 23 is a non-volatile storage that stores software programs such as an operating system (OS), middleware, and application software, and data. The information processing apparatus 20 may include another type of non-volatile storage such as a flash memory or a solid state drive (SSD).

The GPU 24 performs image processing in cooperation with the CPU 21, and outputs an image to a display device 24a connected to the information processing apparatus 20. The display device 24a is, for example, a cathode ray tube (CRT) display, a liquid crystal display, an organic electro luminescence (EL) display, or a projector. Another type of output device such as a printer may be connected to the information processing apparatus 20.

The GPU 24 may be used as a general purpose computing on graphics processing unit (GPGPU). The GPU 24 is able to execute a program in accordance with an instruction from the CPU 21. The information processing apparatus 20 may include a volatile semiconductor memory other than the RAM 22 as a GPU memory.

The input interface 25 receives an input signal from an input device 25a connected to the information processing apparatus 20. The input device 25a is, for example, a mouse, a touch panel, or a keyboard. A plurality of input devices may be connected to the information processing apparatus 20.

The media reader 26 is a reading device that reads a program and data recorded in a recording medium 26a. The recording medium 26a is, for example, a magnetic disk, an optical disc, or a semiconductor memory. Examples of the magnetic disk include a flexible disk (FD) and an HDD. Examples of the optical disc include a compact disc (CD) and a digital versatile disc (DVD). The media reader 26 copies the program and data read from the recording medium 26a to another recording medium such as the RAM 22 or the HDD 23. The read program may be executed by the CPU 21.

The recording medium 26a may be a portable recording medium. The recording medium 26a may be used for distribution of programs and data. The recording medium 26a and the HDD 23 may be referred to as a computer-readable recording medium.

The communication interface 27 communicates with other information processing apparatuses via a network 27a. The communication interface 27 may be a wired communication interface connected to a wired communication device such as a switch or a router, or may be a wireless communication interface connected to a wireless communication device such as a base station or an access point.

Next, functions of the information processing apparatus 20 will be described.

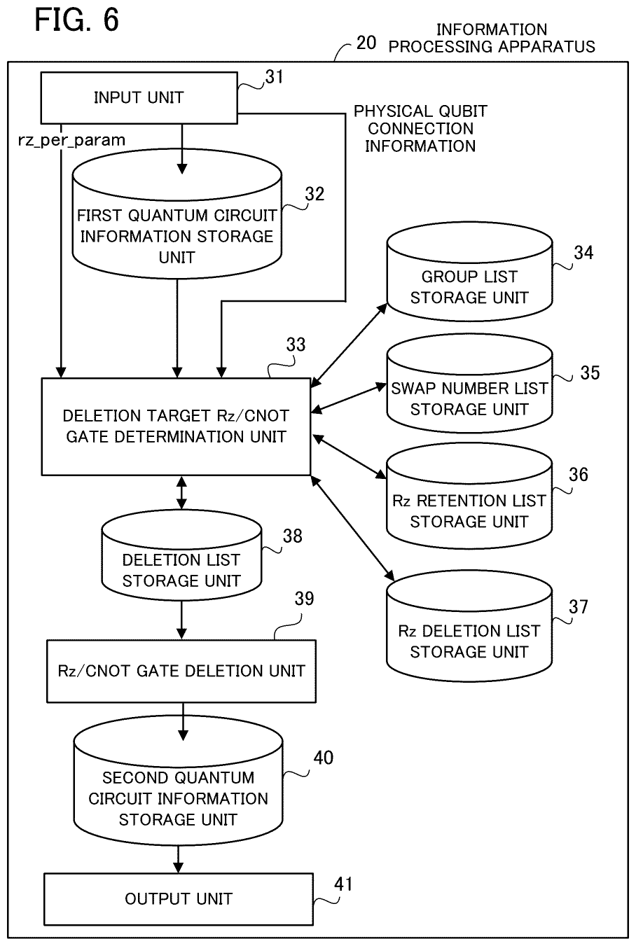

FIG. 6 is a block diagram illustrating a functional example of the information processing apparatus.

The information processing apparatus 20 includes an input unit 31, a first quantum circuit information storage unit 32, a deletion target Rz/CNOT gate determination unit 33, a group list storage unit 34, a swap number list storage unit 35, an Rz retention list storage unit 36, an Rz deletion list storage unit 37, and a deletion list storage unit 38. The information processing apparatus 20 further includes an Rz/CNOT gate deletion unit 39, a second quantum circuit information storage unit 40, and an output unit 41.

Each of the storage units is implemented using, for example, the RAM 22 or the HDD 23. The input unit 31, the deletion target Rz/CNOT gate determination unit 33, the Rz/CNOT gate deletion unit 39, and the output unit 41 are implemented using, for example, the CPU 21 and a program.

First quantum circuit information representing a first quantum circuit whose weight is to be reduced and input data such as the above-described rz_per_param are input to the input unit 31. As illustrated in FIGS. 1 and 2, the first quantum circuit includes a plurality of Rz gates and a plurality of groups of CNOT gates, each group accompanying a corresponding one of the plurality of Rz gates, and is used for VQE. The input unit 31 may further receive physical qubit connection information described below as input data. The first quantum circuit information, rz_per_param, or physical qubit connection information is input via, for example, the recording medium 26a or the network 27a. The user may enter the rz_per_param and the physical qubit connection information by operating the input device 25a. The information processing apparatus 10 may generate the first quantum circuit information.

The first quantum circuit information storage unit 32 stores the first quantum circuit information.

The deletion target Rz/CNOT gate determination unit 33 determines the deletion target Rz gates and CNOT gates to be deleted from the first quantum circuit.

The group list storage unit 34 stores a list of groups (hereinafter, referred to as a group list), each of which includes an Rz gate and a group of CNOT gates accompanying Rz gate in the first quantum circuit. The group list may be expressed as, for example, {Rz-ID: [CNOT-ID, . . . ], . . . }. Rz-ID is an ID of an Rz gate, and CNOT-ID is an ID of each of the plurality of CNOT gates accompanying the Rz gate. These IDs are obtained from the first quantum circuit information.

The swap number list storage unit 35 stores the physical qubit connection information and a list of the numbers of swap gates, each accompanying an Rz gate. The list is obtained from the first quantum circuit information (hereinafter referred to as a swap number list). The swap number list may be expressed, for example, as {Rz-ID: swap gate number, . . . }. These swap gates will be described below.

The Rz retention list storage unit 36 stores a list of the number of retained Rz gates determined for each angle parameter (hereinafter referred to as an Rz retention list). The Rz retention list may be expressed as {parameter ID: counter value, . . . }. The “parameter ID” is an ID of an angle parameter. The counter value is a value of a counter that counts the retained Rz gates.

The Rz deletion list storage unit 37 stores a list of deletion target Rz gates (hereinafter referred to as an Rz deletion list). The Rz deletion list may be represented by the IDs of the deletion target Rz gates.

The deletion list storage unit 38 stores a list of deletion target Rz gates and CNOT gates (hereinafter referred to as a deletion list). The deletion list may be represented by the IDs of the deletion target Rz gates and CNOT gates.

The Rz/CNOT gate deletion unit 39 generates second quantum circuit information representing a second quantum circuit obtained by deleting the determined Rz gates and CNOT gates from the first quantum circuit in accordance with the deletion list.

The second quantum circuit information storage unit 40 stores the generated second quantum circuit information.

The output unit 41 outputs the second quantum circuit information. For example, the output unit 41 may output the second quantum circuit information to the display device 24a and may cause the display device 24a to display the second quantum circuit information. The output unit 41 may transmit the second quantum circuit information to another information processing apparatus via the network 27a.

FIG. 7 is a diagram illustrating a connection example of physical qubits and an example of a quantum circuit before and after transpiration.

In the example in FIG. 7, a connection example of physical qubits of a quantum device of four qubits (four qubit device) is illustrated. A qubit q₀ is connected to a qubit q₁, and the qubit q₁ is further connected to a qubit q₂. The qubit q₂ is further connected to a qubit q₃. That is, direct coupling acts between the nearest qubits, and quantum connection is made.

In addition, FIG. 7 illustrates an example of a quantum circuit 50 of four qubits before transpiration, the quantum circuit 50 including Rz gates and CNOT gates. The two CNOT gates accompanying the left Rz gate generate quantum entanglement between the qubits q₀ and q₁. In the quantum device having the above-described connection example, because the qubits q₀ and q₁ are quantum-mechanically connected, it is possible to implement CNOT gates that generate quantum entanglement between the qubits q₀ and q₁.

However, in the quantum circuit 50, the two CNOT gates accompanying the right Rz gate generate quantum entanglement between the qubits q₀ and q₃. In the quantum device having the above-described connection example, because the qubits q₀ and q₃ are not quantum-mechanically connected, CNOT gates that generate quantum entanglement between the qubits q₀ and q₃ are not implementable as it is. Therefore, the quantum circuit 50 is converted (referred to as transpiration) into a quantum circuit corresponding to the connection state of the physical qubits as described above.

In a quantum circuit 51, which is obtained after the conversion, the right Rz gate is accompanied by two CNOT-gates for generating quantum entanglement between the qubits q₀ and q₁. Further, the right RZ gate is accompanied by swap gates 51a and 51b for interchanging the quantum states between the qubits q₂ and q₃ and swap gates 51c and 51d for interchanging the quantum states between the qubits q₁ and q₂. Each of the swap gates 51a to 51d are formed by three CNOT gates.

In the quantum circuit 50 as illustrated in FIG. 7, when the left Rz gate is deleted, it is possible to delete the two CNOT gates accompanying this Rz gate. On the other hand, when the right Rz gate is deleted, it is possible to delete the two CNOT gates accompanying this Rz gate in the quantum circuit 50. However, in the case of the quantum circuit 51, which is obtained after the conversion, it is possible to delete 14 CNOT gates (2+3×4=14) when the right Rz gate is deleted.

Therefore, the information processing apparatus 20 may preferentially determine, as a deletion target, an Rz gate accompanied by a large number of swap gates after the transpiration, based on the above-described physical qubit connection information representing the connection state of the physical qubits of the quantum device.

Next, a processing procedure of a quantum circuit weight reduction method executed by the information processing apparatus 20 will be described.

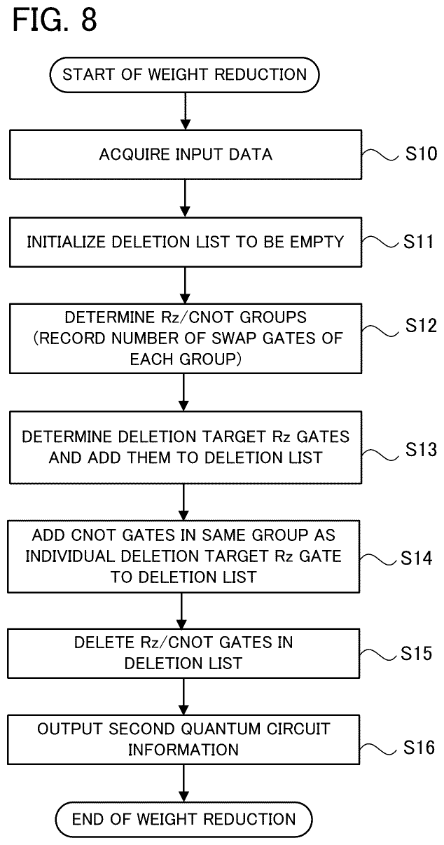

FIG. 8 is a flowchart illustrating an example of a processing procedure of a quantum circuit weight reduction method.

(Step S10) When the quantum circuit weight reduction process starts, the deletion target Rz/CNOT gate determination unit 33 of the information processing apparatus 20 acquires input data (first quantum circuit information and rz_per_param). If the physical qubit connection information is input, the deletion target Rz/CNOT gate determination unit 33 also acquires the physical qubit connection information as input data.

(Step S11) The deletion target Rz/CNOT gate determination unit 33 initializes the deletion list stored in the deletion list storage unit 38 to be empty.

(Step S12) The deletion target Rz/CNOT gate determination unit 33 determines groups, each of which is formed by an Rz gate and a group of CNOT gates accompanying the Rz gate, and records the groups in a group list. If there is physical qubit connection information, the deletion target Rz/CNOT gate determination unit 33 records the number of swap gates of each group in the swap number list. A specific example of the process in step S12 will be described below.

(Step S13) The deletion target Rz/CNOT gate determination unit 33 determines the deletion target Rz gates and adds these Rz gates to the deletion list. A specific example of the process in step S13 will be described below.

(Step S14) The deletion target Rz/CNOT gate determination unit 33 adds the CNOT gates included in the same group as an individual deletion target Rz gate to the deletion list. A specific example of the process in step S14 will be described below.

(Step S15) The Rz/CNOT gate deletion unit 39 deletes the Rz gates and the CNOT gates in the deletion list from the first quantum circuit.

(Step S16) The output unit 41 outputs second quantum circuit information representing a second quantum circuit obtained by deleting the Rz gates and the CNOT gates from the first quantum circuit. Thus, the processing of the information processing apparatus 20 ends.

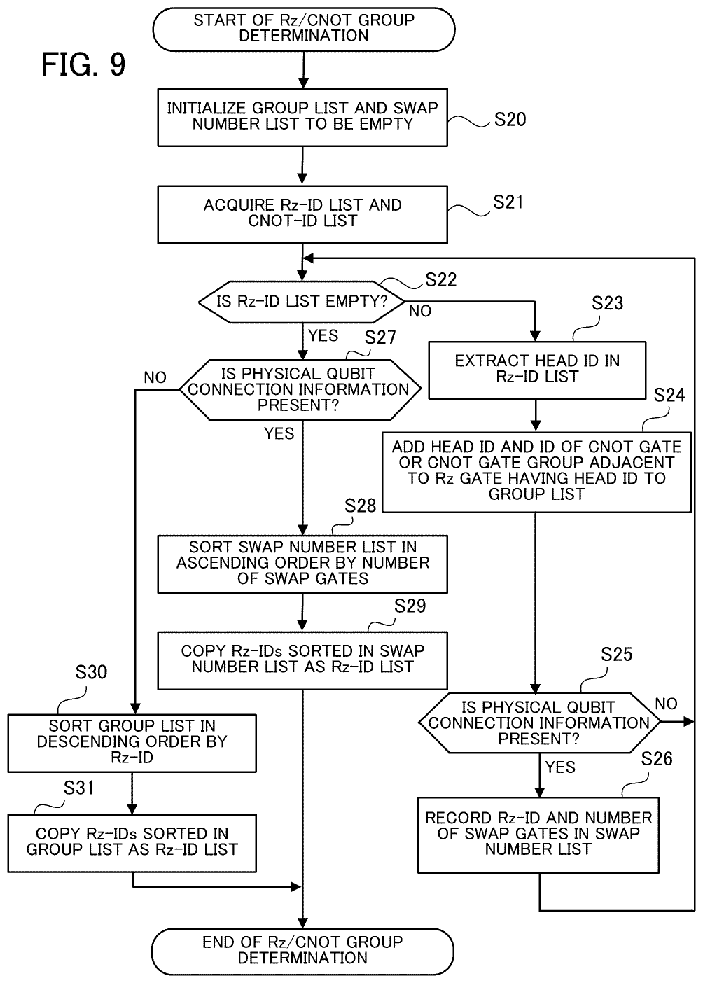

FIG. 9 is a flowchart illustrating an example of an Rz/CNOT group determination procedure. FIG. 9 illustrates an example of the processing procedure in step S12 illustrated in FIG. 8.

(Step S20) The deletion target Rz/CNOT gate determination unit 33 initializes the group list and the swap number list to be empty.

(Step S21) The deletion target Rz/CNOT gate determination unit 33 acquires the Rz-ID list and the CNOT-ID list. The Rz-ID list is a list of the IDs of the Rz gates (Rz-IDs) included in the first quantum circuit. The CNOT-ID list is a list of the IDs of the CNOT gates (CNOT-IDs) included in the first quantum circuit. The Rz-ID list and the CNOT-ID list are included in the first quantum circuit information.

(Step S22) The deletion target Rz/CNOT gate determination unit 33 determines whether the Rz-ID list is empty. If the deletion target Rz/CNOT gate determination unit 33 determines that the Rz-ID list is not empty, the deletion target Rz/CNOT gate determination unit 33 performs the process in step S23. If the deletion target Rz/CNOT gate determination unit 33 determines that the Rz-ID list is empty, the deletion target Rz/CNOT gate determination unit 33 performs the process in step S27.

(Step S23) The deletion target Rz/CNOT gate determination unit 33 extracts the head ID (Rz-ID) in the Rz-ID list.

(Step S24) Based on the first quantum circuit information, the deletion target Rz/CNOT gate determination unit 33 extracts the ID (CNOT-ID) of a CNOT gate or a CNOT gate group adjacent to the Rz gate having the extracted Rz-ID from the CNOT-ID list. Next, the deletion target Rz/CNOT gate determination unit 33 adds the extracted Rz-ID and CNOT-ID to the group list as an ID group belonging to one group.

(Step S25) The deletion target Rz/CNOT gate determination unit 33 determines whether physical qubit connection information is present. If the deletion target Rz/CNOT gate determination unit 33 determines that physical qubit connection information is present, the deletion target Rz/CNOT gate determination unit 33 performs the process in step S26. If the deletion target Rz/CNOT gate determination unit 33 determines that no physical qubit connection information is present, the deletion target Rz/CNOT gate determination unit 33 returns to the process in step S22.

(Step S26) The deletion target Rz/CNOT gate determination unit 33 records the Rz-ID extracted in the process in step S23 and the number of swap gates in the swap number list. The number of swap gates is calculated based on the physical qubit connection information and the CNOT gate or the CNOT gate group added to the group list in the process in step S24.

For example, it is assumed that the physical qubit connection information indicating the connection state of the qubits q₀ to q₃ as illustrated in FIG. 7 is input. When the first quantum circuit before the weight reduction is the quantum circuit 50 as illustrated in FIG. 7, the CNOT gate accompanying the right Rz gate generates quantum entanglement between the qubits q₀ and q₃. When the distance between adjacent qubits is 1, the distance between the qubits q₀ and q₃ is 3. The value obtained by subtracting 1 from this distance is the number of swap gates generated after the transpiration for that CNOT gate.

After the process in step S26, the process in step S22 is performed again.

(Step S27) The deletion target Rz/CNOT gate determination unit 33 determines whether physical qubit connection information is present. If the deletion target Rz/CNOT gate determination unit 33 determines that physical qubit connection information is present, the deletion target Rz/CNOT gate determination unit 33 performs the process in step S28. If the deletion target Rz/CNOT gate determination unit 33 determines that physical qubit connection information is not present, the deletion target Rz/CNOT gate determination unit 33 performs the process in step S30.

(Step S28) The deletion target Rz/CNOT gate determination unit 33 sorts the swap number list in ascending order by the number of swap gates. Therefore, the Rz-ID of an Rz gate having a smaller number of accompanying swap gates after the transpiration is listed closer to the head in the swap number list.

(Step S29) The deletion target Rz/CNOT gate determination unit 33 copies the Rz-IDs sorted in the swap number list as an Rz-ID list.

(Step S30)) The deletion target Rz/CNOT gate determination unit 33 sorts the group list in descending order by Rz-ID. Note that a smaller Rz-ID is assigned to an Rz gate that acts earlier on a qubit in the first quantum circuit. Therefore, the Rz-ID of an Rz gate that acts on a qubit later is listed closer to the head in the group list.

(Step S31) The deletion target Rz/CNOT gate determination unit 33 copies the Rz-IDs in the sorted group list as an Rz-ID list.

After the process in step S29 or step S31, the Rz/CNOT group determination process (the process in step S12 in FIG. 8) ends.

By the above processing, the Rz-ID of an Rz gate having a smaller number of accompanying swap gates after the transpiration is listed closer to the head in the Rz list. Alternatively, the Rz-ID of an Rz gate that acts on a qubit later is listed closer to the head in the Rz list.

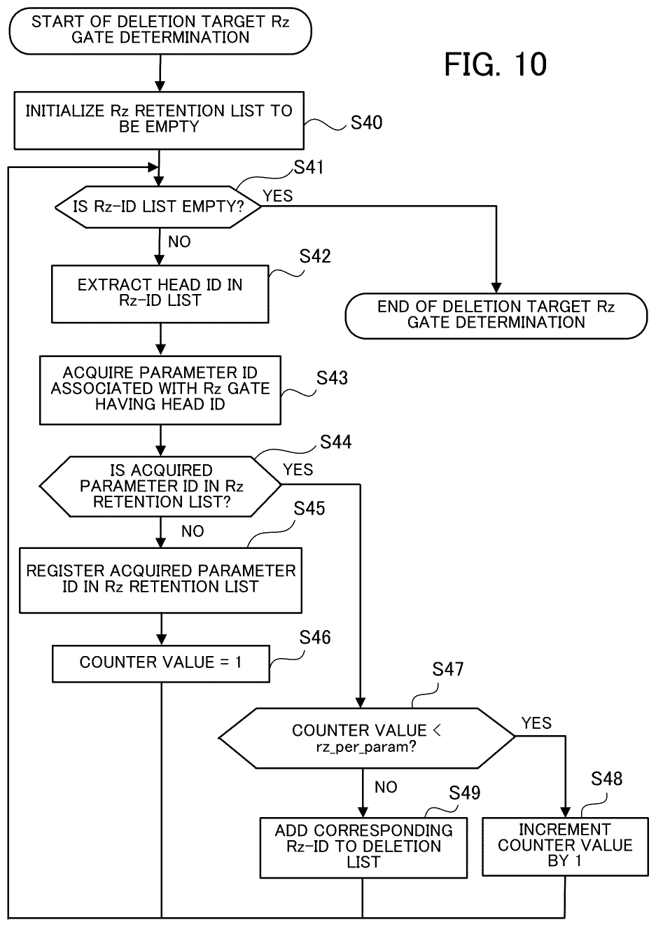

FIG. 10 is a flowchart illustrating an example of a deletion target Rz gate determination procedure. FIG. 10 illustrates an example of the processing procedure in step S13 illustrated in FIG. 8.

(Step S40) The deletion target Rz/CNOT gate determination unit 33 initializes the Rz retention list to be empty.

(Step S41) The deletion target Rz/CNOT gate determination unit 33 determines whether the Rz-ID list obtained in the process in step S29 or step S31 described above is empty. If the deletion target Rz/CNOT gate determination unit 33 determines that the Rz-ID list is not empty, the deletion target Rz/CNOT gate determination unit 33 performs the process in step S42. If the deletion target Rz/CNOT gate determination unit 33 determines that the Rz-ID list is empty, the deletion target Rz/CNOT gate determination unit 33 ends the deletion target Rz gate determination process.

(Step S42) The deletion target Rz/CNOT gate determination unit 33 extracts the head ID (Rz-ID) in the Rz-ID list.

(Step S43) The deletion target Rz/CNOT gate determination unit 33 acquires the ID (parameter ID) of the angle parameter associated with the Rz gate having the head ID from the first quantum circuit information. When the first quantum circuit 13a as illustrated in FIG. 1 is used, first, the parameter ID of the parameter P0 associated with the left Rz gate is acquired.

(Step S44) The deletion target Rz/CNOT gate determination unit 33 determines whether the acquired parameter ID is in the Rz retention list. If the deletion target Rz/CNOT gate determination unit 33 determines that the acquired parameter ID is not in the Rz retention list, the deletion target Rz/CNOT gate determination unit 33 performs the process in step S45. If the deletion target Rz/CNOT gate determination unit 33 determines that the acquired parameter ID is in the Rz retention list, the deletion target Rz/CNOT gate determination unit 33 performs the process in step S47.

(Step S45) The deletion target Rz/CNOT gate determination unit 33 registers the acquired parameter ID in the Rz retention list.

(Step S46) The deletion target Rz/CNOT gate determination unit 33 sets the value of the above-described counter that counts the retained Rz gates associated with the angle parameter of the acquired parameter ID to 1, and returns to the process in step S41.

(Step S47) The deletion target Rz/CNOT gate determination unit 33 determines whether the counter value of the Rz gate associated with the angle parameter of the acquired parameter ID is smaller than rz_per_param. If the deletion target Rz/CNOT gate determination unit 33 determines that the counter value is smaller than rz_per_param, the deletion target Rz/CNOT gate determination unit 33 performs the process in step S48. If the deletion target Rz/CNOT gate determination unit 33 determines that the counter value is equal to or greater than rz_per_param, the deletion target Rz/CNOT gate determination unit 33 performs the process in step S49.

(Step S48) The deletion target Rz/CNOT gate determination unit 33 increments the counter value by 1. As a result, the number of retained Rz gates is increased by +1.

(Step S49) The deletion target Rz/CNOT gate determination unit 33 adds the Rz-ID extracted in the process in step S42 to the deletion list.

After the process in step S48 or S49, the process in step S41 is performed again.

By the above processing, the Rz-IDs of the Rz gates are added to the deletion list by the number obtained by subtracting the product of rz_per_param and the number of parameters in the first quantum circuit 13a from the total number of Rz gates.

Since the Rz-IDs are extracted from the head of the Rz-ID list in the process in step S42, the Rz-ID located at the end of the Rz-ID list is more likely to be added to the deletion list. As described above, the Rz-ID of an Rz gate having a smaller number of accompanying swap gates after the transpiration is listed closer to the head of the Rz list. Alternatively, the Rz-ID of an Rz gate that acts on the qubit later is listed closer to the head of the Rz list.

Therefore, the Rz-ID of an Rz gate having a larger number of accompanying swap gates after the transpiration is more likely to be added to the deletion list. That is, an Rz gate having a larger number of accompanying swap gates after the transpiration is preferentially set as a deletion target.

In addition, the Rz-ID of an Rz gate that acts on the qubit earlier is more likely to be added to the deletion list. That is, an Rz gate that acts on the qubit earlier is preferentially set as a deletion target.

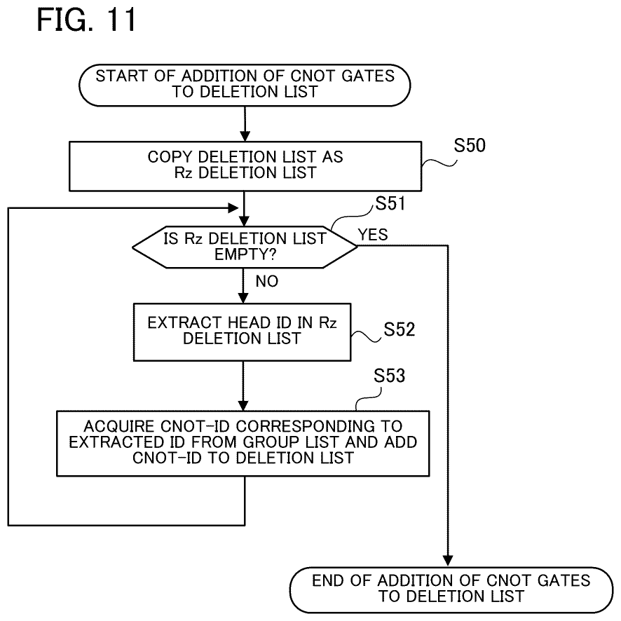

FIG. 11 is a flowchart illustrating an example of a procedure for adding CNOT gates to the deletion list. FIG. 11 illustrates an example of the processing procedure in step S14 illustrated in FIG. 8.

(Step S50) The deletion target Rz/CNOT gate determination unit 33 copies the deletion list as an Rz deletion list.

(Step S51) The deletion target Rz/CNOT gate determination unit 33 determines whether the Rz deletion list is empty. If the deletion target Rz/CNOT gate determination unit 33 determines that the Rz deletion list is not empty, the deletion target Rz/CNOT gate determination unit 33 performs the process in step S52. If the deletion target Rz/CNOT gate determination unit 33 determines that the Rz deletion list is empty, the deletion target Rz/CNOT gate determination unit 33 ends the process of adding a CNOT gate to the deletion list.

(Step S52) The deletion target Rz/CNOT gate determination unit 33 extracts the head ID (Rz-ID) in the Rz deletion list.

(Step S53) The deletion target Rz/CNOT gate determination unit 33 acquires the CNOT-ID corresponding to the extracted Rz-ID from the group list, and adds the CNOT-ID to the deletion list.

After the process in step S53, the processes from step S51 are repeated.

The order of the processes illustrated in FIGS. 9 to 11 is not limited to the above example, and may be appropriately changed.

As described above, the deletion target Rz/CNOT gate determination unit 33 of the information processing apparatus 20 acquires first quantum circuit information representing a first quantum circuit that includes a plurality of Rz gates and a plurality of groups of CNOT gates, each group accompanying a corresponding one of the plurality of Rz gates, and that is used for VQE. In addition, the deletion target Rz/CNOT gate determination unit 33 acquires the number of Rz gates for each angle parameter rz_per_param. Further, the deletion target Rz/CNOT gate determination unit 33 determines the deletion target Rz gate from the first quantum circuit based on the first quantum circuit information and rz_per_param, for example, by the process as illustrated in FIG. 10. Next, the Rz/CNOT gate deletion unit 39 quantum circuit generates second information representing a second quantum circuit obtained by deleting the determined Rz gates and the CNOT gates accompanying the determined Rz gates from the first quantum circuit, and the output unit 41 outputs the second quantum circuit information.

Since the second quantum circuit in which the number of CNOT gates has been reduced is obtained by the process, when the second quantum circuit is mounted on an actual quantum device such as NISQ and VQE is executed, the error due to the noise-induced error is reduced.

In addition, the deletion target Rz/CNOT gate determination unit 33 of the information processing apparatus 20 acquires physical qubit connection information representing the connection state of the physical qubits of a quantum device. The deletion target Rz/CNOT gate determination unit 33 calculates, for each of the plurality of Rz gates, the number of swap gates obtained from the plurality of CNOT gates when the transpiration is performed, based on the physical qubit connection information. Next, the deletion target Rz/CNOT gate determination unit 33 preferentially determines an Rz gate having a large number of swap gates calculated, as an deletion target Rz gate. The individual swap gate is formed by three CNOT gates. Thus, by setting an Rz gate having a large number of swap gates as a deletion target, it is possible to delete more CNOT gates, and to further reduce the error due to the noise-induced error.

In addition, the deletion target Rz/CNOT gate determination unit 33 of the information processing apparatus 20 preferentially determines an Rz gate that acts on a qubit earlier as a deletion target Rz gate in the first quantum circuit. This leaves an Rz gate that acts later, which is considered more important for the calculation result.

Note that rz_per_param may be the same value or different values for a plurality of angle parameters. The user may adjust rz_per_param based on the correlation between the number of CNOT gates and the error.

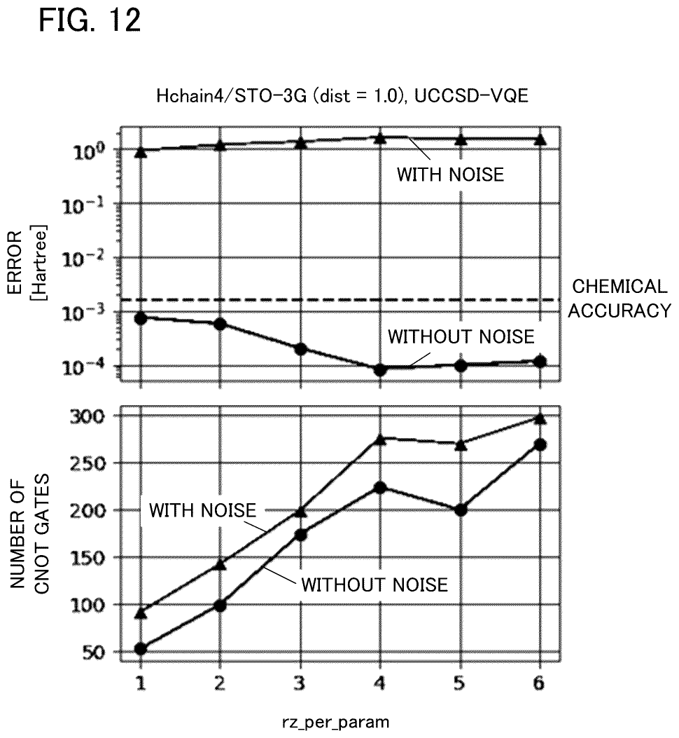

FIG. 12 is a diagram illustrating an example of the correlation among rz_per_param, the error, and the number of CNOT gates. FIG. 12 illustrates an example of the correlation among rz_per_param, the error and the number of CNOT gates in a simulation with noise and in a simulation without noise. The horizontal axis represents rz_per_param, and the vertical axis represents the number of CNOT gates and the error.

In the example in FIG. 12, ansatz by UCCSD of a molecule (Hchain4) in which four hydrogen atoms are arranged in a chain is used. The basis set used is STO-3G. Dist=1.0 indicates that the interatomic distance between hydrogen atoms is 1.0 Å. The error is the difference between the base energy of the Hchain4 obtained by the full configuration interaction method and the base energy of the Hchain4 obtained by VQE.

As illustrated in FIG. 12, in the case of the simulation without noise, the lower the degree of weight reduction of the first quantum circuit (the larger rz_per_param is), the smaller the error. On the other hand, in the case of the simulation with noise, the higher the degree of weight reduction, the smaller the error. This is because a larger number of CNOT gates having a high error rate due to noise is deleted.

As illustrated in FIG. 12, in the case of the simulation without noise, even when the degree of weight reduction is the highest (in the case of rz_per_param=1), the error falls within the chemical accuracy.

Based on such a relationship, the information processing apparatus 20 is able to adjust rz_per_param such that needed accuracy is obtained.

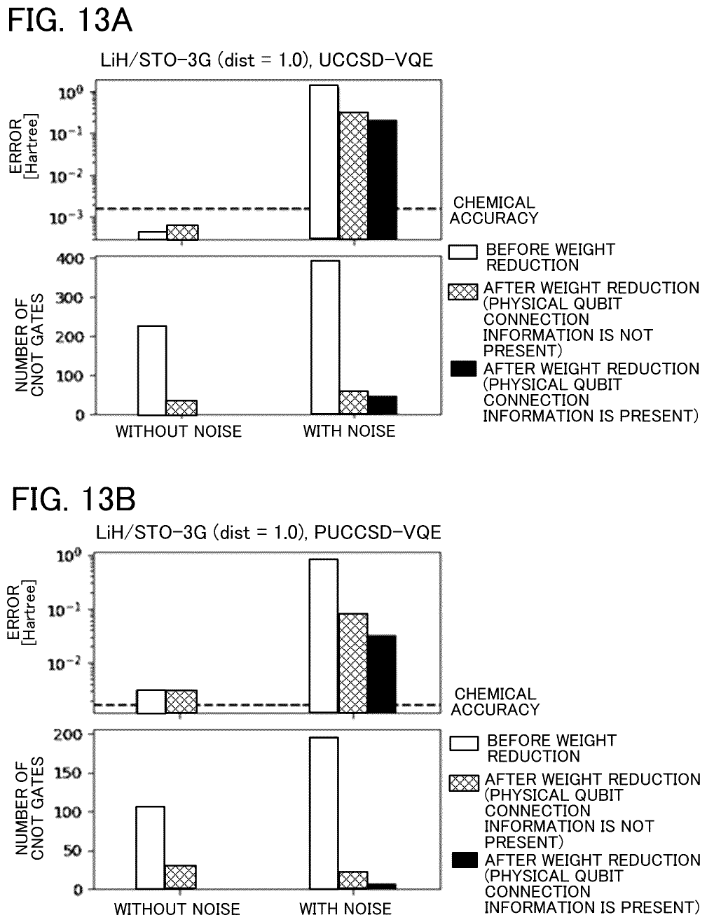

FIGS. 13A and 13B are diagrams each illustrating an example of an effect of the quantum circuit weight reduction method according to the second embodiment. In FIGS. 13A and 13B, the error and the number of CNOT gates of a quantum circuit before weight t reduction t quantum circuit) and the error and the number of CNOT gates of the quantum circuit after weight reduction are compared in a simulation without noise and in a simulation with noise. Ansatz of LiH is used as in FIG. 3.

The quantum circuit after the weight reduction is obtained by transpiration of the second quantum circuit obtained by the above-described method. There are two types of quantum circuits after weight reduction, that is, a case where physical qubit connection information is present and a case where physical qubit connection information is not present. FIG. 13A illustrates an example in which ansatz of UCCSD is used, and FIG. 13B illustrates an example in which parallel unitary coupled cluster singles and doubles (PUCCSD) is used.

As illustrated in FIGS. 13A and 13B, the number of CNOT gates in the quantum circuit after the weight reduction is significantly less than that in the quantum circuit before the weight reduction (first quantum circuit). This reduces an increase in noise-induced error. In addition, deterioration in accuracy due to weight reduction when there is no noise is also suppressed.

A quantum circuit optimization method of deleting redundant quantum gates from a quantum circuit or merging a plurality of quantum gates may be combined with the above-described quantum circuit weight reduction method. In this case, the quantum circuit optimization method may be applied to the quantum circuit obtained after the weight reduction (second quantum circuit). By applying the quantum circuit optimization method to the second quantum circuit, the number of deleted quantum gates is increased as compared with the case where the quantum circuit optimization method is applied to the first quantum circuit, and it is expected that the circuit obtained after the transpiration is further reduced in weight.

As described above, it is possible to realize the processing content described above by causing the information processing apparatus 20 to execute a program (for example, a quantum circuit weight reduction program).

The program may be recorded in a computer-readable recording medium (for example, the recording medium 26a). As the recording medium, for example, a magnetic disk, an optical disc, a magneto-optical disk, a semiconductor memory, or the like may be used. Examples of the magnetic disk include an FD and an HDD. Examples of the optical disc include a CD, a CD-recordable (CD-R), a CD-rewritable (CD-RW), a DVD, and a DVD-R/RW. The program may be recorded on a portable recording medium and distributed. In this case, the program may be copied from the portable recording medium to another recording medium (for example, the HDD 23) and executed.

In one aspect, a VQE error due to a noise-induced error is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
acquiring first quantum circuit information representing a first quantum circuit that includes a plurality of Rz gates and a plurality of groups of CNOT gates, each group accompanying a corresponding one of the plurality of Rz gates, and that is used for variational quantum eigensolver (VQE), and a number of Rz gates for each angle parameter;
determining a deletion target Rz gate from the plurality of Rz gates included in the first quantum circuit based on the first quantum circuit information and the number of Rz gates;
generating second quantum circuit information representing a second quantum circuit obtained by deleting the determined Rz gate and a CNOT gate accompanying the determined Rz gate from the first quantum circuit; and
outputting the second quantum circuit information.

2. The non-transitory computer-readable recording medium according to claim 1, wherein the process includes:
further acquiring physical qubit connection information representing a connection state of physical qubits of a quantum device;
calculating, for each of the plurality of Rz gates, a number of swap gates obtained from the plurality of CNOT gates when the first quantum circuit is converted into a third quantum circuit corresponding to the connection state, based on the physical qubit connection information; and
preferentially determining an Rz gate having a large number of swap gates calculated, as the deletion target Rz gate.

3. The non-transitory computer-readable recording medium according to claim 1, wherein among Rz gates having a same angle parameter in the first quantum circuit, an Rz gate that acts on a qubit earlier is preferentially determined as the deletion target Rz gate.

4. An information processing apparatus comprising:
a memory configured to store first quantum circuit information representing a first quantum circuit that includes a plurality of Rz gates and a plurality of groups of CNOT gates, each group accompanying a corresponding one of the plurality of Rz gates, and that is used for VQE; and
a processor coupled to the memory and the processor configured to:
acquire the first quantum circuit information and a number of Rz gates for each angle parameter;
determine a deletion target Rz gate from the plurality of Rz gates included in the first quantum circuit based on the first quantum circuit information and the number of Rz gates;
generate second quantum circuit information representing a second quantum circuit obtained by deleting the determined Rz gate and a CNOT gate accompanying the determined Rz gate from the first quantum circuit; and
output the second quantum circuit information.

5. A quantum circuit weight reduction method comprising:
acquiring, by a processor, first quantum circuit information representing a first quantum circuit that includes a plurality of Rz gates and a plurality of groups of CNOT gates, each group accompanying a corresponding one of the plurality of Rz gates, and that is used for VQE, and a number of Rz gates for each angle parameter;
determining, by the processor, a deletion target Rz gate from the plurality of Rz gates included in the first quantum circuit based on the first quantum circuit information and the number of Rz gates;
generating, by the processor, second quantum circuit information representing a second quantum circuit obtained by deleting the determined Rz gate and a CNOT gate accompanying the determined Rz gate from the first quantum circuit; and
outputting, by the processor, the second quantum circuit information.

6. The quantum circuit weight reduction method according to claim 5, further comprising:
further acquiring, by the processor, physical qubit connection information representing a connection state of physical qubits of a quantum device;
calculating, by the processor, for each of the plurality of Rz gates, a number of swap gates obtained from the plurality of CNOT gates when the first quantum circuit is converted into a third quantum circuit corresponding to the connection state, based on the physical qubit connection information; and
preferentially determining, by the processor, an Rz gate having a large number of swap gates calculated, as the deletion target Rz gate.

7. The quantum circuit weight reduction method according to claim 5, further comprising preferentially determining, by the processor, among Rz gates having a same angle parameter in the first quantum circuit, an Rz gate that acts on a qubit earlier, as the deletion target Rz gate.
